(19) United States
(12) Patent Application Publication
(10) Pub. No.: US 2025/0309351 A1
(43) Pub. Date: Oct. 2, 2025

(54) ELECTROLYTIC SOLUTION FOR SECONDARY BATTERY, AND SECONDARY BATTERY

(71) Applicant: MURATA MANUFACTURING CO., LTD., Kyoto (JP)

(72) Inventors: Daisuke MORI, Kyoto (JP); Aiko KANAZAWA, Kyoto (JP); Yoshiaki SUZUKI, Kyoto (JP); Yuri NAKAYAMA, Kyoto (JP); Hideki KAWASAKI, Kyoto (JP)

(21) Appl. No.: 19/240,395

(22) Filed: Jun. 17, 2025

Related U.S. Application Data
(63) Continuation of application No. PCT/JP2023/042184, filed on Nov. 24, 2023.

(30) Foreign Application Priority Data
Jan. 6, 2023 (JP) 2023-000959

(51) Int. Cl. H01M 10/0567; H01M 4/02; H01M 4/46; H01M 10/054; H01M 10/0568; H01M 10/0569

(52) U.S. Cl. CPC H01M 10/0567; H01M 4/466; H01M 10/054; H01M 10/0568; H01M 10/0569; H01M 2004/027; H01M 2004/028; H01M 2300/0025

(57) ABSTRACT

A secondary battery includes a positive electrode, a negative electrode, and an electrolytic solution. The electrolytic solution includes a magnesium salt and a cyclic unsaturated hydrocarbon compound. The cyclic unsaturated hydrocarbon compound includes a monocyclic ring including multiple carbon atoms or a bicyclic fused ring including multiple carbon atoms. The monocyclic ring or the bicyclic fused ring includes two or more carbon-carbon double bonds. The bicyclic fused ring includes no benzene ring. The number of the carbon-carbon double bonds when the number of the carbon atoms included in the monocyclic ring is 7 or less is an even number. The number of the carbon-carbon double bonds when the number of the carbon atoms included in the monocyclic ring is 8 or more is an odd number or an even number. The number of the carbon-carbon double bonds in the bicyclic fused ring is an odd number or an even number.

### CROSS REFERENCE TO RELATED APPLICATIONS

The present application is a continuation of International Application No. PCT/JP2023/042184, filed on Nov. 24, 2023, which claims priority to Japanese Patent Application No. 2023-000959, filed on Jan. 6, 2023, the entire contents of which are incorporated herein by reference.

### BACKGROUND

The present technology relates to an electrolytic solution for a secondary battery, and to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolytic solution (an electrolytic solution for a secondary battery). A configuration of the secondary battery has been considered in various ways.

Specifically, in a secondary battery in which charging and discharging reactions proceed through precipitation and dissolution of magnesium, an electrolytic solution includes a compound having an unsaturated hydrocarbon skeleton, such as anthracene

### SUMMARY

The present technology relates to an electrolytic solution for a secondary battery, and to a secondary battery.

A battery characteristic of a secondary battery is not sufficient yet. Accordingly, there is room for improvement in terms of the battery characteristic of the secondary battery.

It is desirable to provide an electrolytic solution for a secondary battery and a secondary battery each of which makes it possible to achieve a superior battery characteristic.

An electrolytic solution for a secondary battery according to an embodiment of the present technology includes a magnesium salt and a cyclic unsaturated hydrocarbon compound. The cyclic unsaturated hydrocarbon compound includes a monocyclic ring including multiple carbon atoms or a bicyclic fused ring including multiple carbon atoms. The monocyclic ring or the bicyclic fused ring includes two or more carbon-carbon double bonds. The bicyclic fused ring includes no benzene ring. The number of the carbon-carbon double bonds when the number of the carbon atoms included in the monocyclic ring is 7 or less is an even number. The number of the carbon-carbon double bonds when the number of the carbon atoms included in the monocyclic ring is 8 or more is an odd number or an even number. The number of the carbon-carbon double bonds in the bicyclic fused ring is an odd number or an even number.

A secondary battery according to an embodiment of the present technology includes a positive electrode, a negative electrode, and an electrolytic solution. The electrolytic solution has a configuration similar to that of the electrolytic solution for the secondary battery according to an embodiment of the present technology described above.

Here, the “monocyclic ring” is a single carbon ring including multiple carbon atoms. The “bicyclic fused ring” is a ring including multiple carbon atoms and having two carbon rings that are fused to each other, and, as described above, includes no benzene ring. Details of the monocyclic ring and details of the bicyclic fused ring will be described later.

According to the electrolytic solution for the secondary battery of an embodiment of the present technology, and the secondary battery of an embodiment of the present technology, the electrolytic solution for the secondary battery includes the magnesium salt and the cyclic unsaturated hydrocarbon compound, the cyclic unsaturated hydrocarbon compound includes the monocyclic ring or the bicyclic fused ring, the monocyclic ring or the bicyclic fused ring includes two or more carbon-carbon double bonds, the bicyclic fused ring includes no benzene ring, and the number of the carbon-carbon double bonds satisfies the above-described conditions.

Accordingly, it is possible to achieve a superior battery characteristic.

Note that effects of the present technology are not necessarily limited to those described herein and may include any of a series of effects in relation to the present technology.

### BRIEF DESCRIPTION OF THE FIGURES

FIG. 1 is a perspective diagram illustrating a configuration of a secondary battery according to an embodiment of the present technology.

FIG. 2 is a sectional diagram illustrating a configuration of a battery device illustrated in FIG. 1.

FIG. 3 is a sectional diagram illustrating a configuration of a test secondary battery.

### DETAILED DESCRIPTION

The present technology is described below in further detail including with reference to the drawings according to an embodiment.

A description is given first of an electrolytic solution for a secondary battery (hereinafter simply referred to as an “electrolytic solution”) according to an embodiment of the present technology.

The electrolytic solution described here is to be used in a secondary battery, which is an electrochemical device. However, the electrolytic solution may be used in other electrochemical devices besides the secondary battery. Specific examples of the other electrochemical devices include a primary battery and a capacitor.

The electrolytic solution is a liquid electrolyte, and includes an electrolyte salt and an additive.

The electrolyte salt includes any one or more of magnesium salts.

Specific examples of the magnesium salt include magnesium chloride (MgCl₂), magnesium perchlorate (Mg(ClO₄)₂), magnesium nitrate (Mg(NO₃)₂), magnesium sulfate (MgSO₄), magnesium acetate (Mg(CH₃COO)₂), magnesium trifluoroacetate (Mg(CF₃COO)₂), magnesium tetrafluoroborate (Mg(BF₄)₂), magnesium tetraphenylborate (Mg(B(C₆H₅)₄)₂), magnesium hexafluorophosphate (Mg(PF₆)₂), magnesium hexafluoroarsenate (Mg(AsF₆)₂), magnesium bis(hexamethyldisilazide) (Mg[N(Si(CH₃)₃)₂]₂), magnesium bis(trifluoromethanesulfonyl)imide (Mg[N(CF₃SO₂)₂]₂, and magnesium bis[tetra(hexafluoroisopropyl)]borate (Mg[B(OCH(CF₃)₂)₄]₂).

A content (mol/l (=mol/dm³)) of the electrolyte salt in the electrolytic solution is not particularly limited, and may be set as desired. The content of the electrolyte salt described here refers to the content of the electrolyte salt with respect to a solvent to be described later.

The additive includes any one or more of cyclic unsaturated hydrocarbon compounds.

The cyclic unsaturated hydrocarbon compound includes a monocyclic compound, a fused ring compound, or both. Only one monocyclic compound may be used, or two or more monocyclic compounds may be used. Likewise, only one fused ring compound may be used, or two or more fused ring compounds may be used.

The monocyclic compound includes a monocyclic ring including multiple carbon atoms. The monocyclic ring is a single carbon ring including multiple carbon atoms, as described above, and more specifically a hydrocarbon ring in which the multiple carbon atoms are so bonded to each other as to form a single ring.

Accordingly, a heterocyclic ring in which multiple carbon atoms and one or more atoms other than the carbon atom are so bonded to each other as to form a single ring is excluded from the monocyclic ring described herein. Specific examples of the one or more atoms other than the carbon atom include a boron atom, a nitrogen atom, an oxygen atom, a phosphorus atom, and a sulfur atom.

The monocyclic ring includes two or more carbon-carbon double bonds (>C═C<). The two or more carbon-carbon bonds are included in the monocyclic ring and are therefore a portion of the monocyclic ring. Accordingly, when an unsaturated hydrocarbon group (a group including a carbon-carbon double bond) is bonded to a carbon atom included in the monocyclic ring, the carbon-carbon double bond included in the unsaturated hydrocarbon group is not a portion of the monocyclic ring, and is therefore excluded from the carbon-carbon double bond described herein.

The monocyclic ring is not particularly limited in kind as long as the monocyclic ring is a single hydrocarbon ring including two or more carbon-carbon double bonds, and is therefore not particularly limited in the number of the carbon atoms included in the monocyclic ring.

Thus, the monocyclic ring may be a three-membered ring (the number of the carbon atoms included in the monocyclic ring is 3), a four-membered ring (the number of the carbon atoms included in the monocyclic ring is 4), a five-membered ring (the number of the carbon atoms included in the monocyclic ring is 5), a six-membered ring (the number of the carbon atoms included in the monocyclic ring is 6), a seven-membered ring (the number of the carbon atoms included in the monocyclic ring is 7), or an eight-membered ring (the number of the carbon atoms included in the monocyclic ring is 8). Needless to say, the monocyclic ring may be a ring in which the number of the carbon atoms is 9 or more.

Further, positions of the two or more carbon-carbon double bonds included in the monocyclic ring are not particularly limited.

Accordingly, the monocyclic ring may be of a fully conjugated system in which the two or more carbon-carbon double bonds are alternately positioned via a carbon-carbon single bond (≡C—C≡), or may be of a non-fully conjugated system in which the two or more carbon-carbon double bonds are not alternately positioned via the carbon-carbon single bond. When the monocyclic ring is of the non-fully conjugated system, the positions of the two or more carbon-carbon double bonds may be set as desired.

Note, however, that the number of the carbon-carbon double bonds included in the monocyclic ring is set to be of a predetermined value in accordance with the number of the carbon atoms included in the monocyclic ring.

Specifically, the number of the carbon-carbon double bonds when the number of the carbon atoms included in the monocyclic ring is 7 or less is an even number, not an odd number. In contrast, the number of the carbon-carbon double bonds when the number of the carbon atoms included in the monocyclic ring is 8 or more may be either of an odd number and an even number. In other words, the number of the carbon-carbon double bonds included in the monocyclic compound (i.e., whether the number is an odd number or an even number) differs depending on the number of the carbon atoms included in the monocyclic ring.

Specific examples of the monocyclic compound are as described below.

Specific examples of the monocyclic compound when the number of the multiple carbon atoms included in the monocyclic ring is 7 or less include cyclotetradiene (the number of the carbon atoms included in the monocyclic ring is 4 and the number of the carbon-carbon double bonds is 2) and cyclopentadiene (the number of the carbon atoms included in the monocyclic ring is 5 and the number of the carbon-carbon double bonds is 2).

Accordingly, for example, benzene (the number of the carbon atoms included in the monocyclic ring is 6 and the number of the carbon-carbon double bonds is 3) and cycloheptatriene (the number of the carbon atoms included in the monocyclic ring is 7 and the number of the carbon-carbon double bonds is 3) are excluded from the specific examples of the monocyclic compound described herein.

Specific examples of the monocyclic compound when the number of the the multiple carbon atoms included in the monocyclic ring is 8 or more include cyclooctatetraene (the number of the carbon atoms included in the monocyclic ring is 8 and the number of the carbon-carbon double bonds is 4), cyclooctatriene (the number of the carbon atoms included in the monocyclic ring is 8 and the number of the carbon-carbon double bonds is 3), cyclotetradecaheptaene (the number of the carbon atoms included in the monocyclic ring is 14 and the number of the carbon-carbon double bonds is 7), and cyclooctadecanonaene (the number of the carbon atoms included in the monocyclic ring is 18 and the number of the carbon-carbon double bonds is 9).

The fused ring compound includes a bicyclic fused ring including multiple carbon atoms. The bicyclic fused ring is a ring including multiple carbon atoms and having two carbon rings that are fused to each other, as described above. More specifically, the bicyclic fused ring is a hydrocarbon ring in which the multiple carbon atoms are so bonded to each other as to form two rings.

Accordingly, a heterocyclic ring in which multiple carbon atoms and one or more atoms other than the carbon atom are so bonded to each other as to form two rings is excluded from the bicyclic fused ring described herein. Details of the one or more atoms other than the carbon atom are as described above.

Note that the bicyclic fused ring includes no benzene ring. That is, the bicyclic fused ring includes two carbon rings that are fused to each other as described above; however, neither of the two carbon rings is the benzene ring.

The bicyclic fused ring includes two or more carbon-carbon double bonds. The two or more carbon-carbon bonds are included in the bicyclic fused ring and are therefore a portion of the bicyclic fused ring. Accordingly, when an unsaturated hydrocarbon group (a group including a carbon-carbon double bond) is bonded to a carbon atom included in the bicyclic fused ring, the carbon-carbon double bond included in the unsaturated hydrocarbon group is excluded from the carbon-carbon double bond described herein.

The bicyclic fused ring is not particularly limited in kind as long as the bicyclic fused ring is a hydrocarbon ring including two or more carbon-carbon double bonds and having two rings that are fused to each other, and is therefore not particularly limited in the number of the carbon atoms included in the bicyclic fused ring.

Thus, the bicyclic fused ring may be a fused ring of two three-membered rings (the number of the carbon atoms included in the bicyclic fused ring is 4), a fused ring of a three-membered ring and a four-membered ring (the number of the carbon atoms included in the bicyclic fused ring is 5), a fused ring of two four-membered rings (the number of the carbon atoms included in the bicyclic fused ring is 6), a fused ring of a four-membered ring and a five-membered ring (the number of the carbon atoms included in the bicyclic fused ring is 7), a fused ring of two five-membered rings (the number of the carbon atoms included in the bicyclic fused ring is 8), or a fused ring of a five-membered ring and a six-membered ring (the number of the carbon atoms included in the bicyclic fused ring is 9).

Further, the bicyclic fused ring may be a fused ring of two six-membered rings (the number of the carbon atoms included in the bicyclic fused ring is 10), a fused ring of a six-membered ring and a seven-membered ring (the number of the carbon atoms included in the bicyclic fused ring is 11), a fused ring of two seven-membered rings (the number of the carbon atoms included in the bicyclic fused ring is 12), a fused ring of a seven-membered ring and an eight-membered ring (the number of the carbon atoms included in the bicyclic fused ring is 13), or a fused ring of two eight-membered rings (the number of the carbon atoms included in the bicyclic fused ring is 14).

Needless to say, the bicyclic fused ring may be a fused ring other than the above-described series of fused rings.

Further, positions of the two or more carbon-carbon double bonds included in the bicyclic fused ring are not particularly limited.

Accordingly, the bicyclic fused ring may be of the fully conjugated system in which the two or more carbon-carbon double bonds are alternately positioned via the carbon-carbon single bond, or may be of the non-fully conjugated system in which the two or more carbon-carbon double bonds are not alternately positioned via the carbon-carbon single bond. When the bicyclic fused ring is of the non-fully conjugated system, the positions of the two or more carbon-carbon double bonds may be set as desired.

Further, the number of the carbon-carbon double bonds included in the bicyclic fused ring is not particularly limited, and may be set as desired. Specifically, the number of the carbon-carbon double bonds may be either of an odd number and an even number. In other words, the number of the carbon-carbon double bonds included in the fused ring compound (i.e., whether the number is an odd number or an even number) does not depend on the number of the carbon atoms included in the bicyclic fused ring, and may be set as desired.

Specific examples of the fused ring compound include pentalene that is a fused ring of two five-membered rings (the number of the carbon atoms included in the bicyclic fused ring is 8 and the number of the carbon-carbon double bonds is 4), azulene that is a fused ring of a five-membered ring and an eight-membered ring (the number of the carbon atoms included in the bicyclic fused ring is 11 and the number of the carbon-carbon double bonds is 5), and heptalene that is a fused ring of two seven-membered rings (the number of the carbon atoms included in the bicyclic fused ring is 12 and the number of the carbon-carbon double bonds is 6).

Accordingly, for example, tetralin that is a fused ring of cyclohexane and benzene, i.e., two six-membered rings (the number of the carbon atoms included in the bicyclic fused ring is 10 and the number of the carbon-carbon double bonds is 3), naphthalene that is a fused ring of two benzene rings, i.e., two six-membered rings (the number of the carbon atoms included in the bicyclic fused ring is 10 and the number of the carbon-carbon double bonds is 5), and anthracene that is a fused ring of three benzene rings, i.e., three six-membered rings (the number of the carbon atoms included in the bicyclic fused ring is 14 and the number of the carbon-carbon double bonds is 7) are excluded from the specific examples of the fused ring compound described herein.

A content of the cyclic unsaturated hydrocarbon compound in the electrolytic solution is not particularly limited, and may be set as desired. As described above, the cyclic unsaturated hydrocarbon compound may include only the monocyclic compound, only the fused ring compound, or both the monocyclic compound and the fused ring compound.

When checking the presence of the cyclic unsaturated hydrocarbon compound in the electrolytic solution and measuring the content of the cyclic unsaturated hydrocarbon compound in the electrolytic solution, the electrolytic solution is analyzed by any one or more of of existing analysis methods. The analysis method is not particularly limited in kind, and specific examples thereof include inductively coupled plasma (ICP) optical emission spectroscopy, nuclear magnetic resonance (NMR) spectroscopy, and gas chromatography mass spectrometry (GC-MS).

One reason why the electrolytic solution includes the cyclic unsaturated hydrocarbon compound is that this makes it easier for oxidation and reduction reactions utilizing precipitation and dissolution of magnesium to proceed stably. Accordingly, in the secondary battery including the electrolytic solution, it becomes easier for the charging and discharging reactions to proceed stably and continuously, and a battery capacity is prevented from decreasing easily even upon repeated charging and discharging.

To be more specific, in a case where the electrolytic solution includes the cyclic unsaturated hydrocarbon compound, activity of magnesium is improved in the progress of precipitation and dissolution reactions of magnesium as compared with a case where the electrolytic solution includes no cyclic unsaturated hydrocarbon compound. As a result, the oxidation and reduction reactions utilizing precipitation and dissolution of magnesium proceed easily, which allows the charging and discharging reactions to proceed easily in the secondary battery including the electrolytic solution.

Note that the case where the electrolytic solution includes no cyclic unsaturated hydrocarbon compound refers to a case where the electrolytic solution includes no additive and a case where the electrolytic solution includes, as an additive, another compound in place of the cyclic unsaturated hydrocarbon compound. Specific examples of the other compound include anthracene, etc., as described above.

Moreover, the cyclic unsaturated hydrocarbon compound undergoes deanionization in a reduced state, and thus becomes an electrochemically stable active species in the electrolytic solution. The active species is not easily decomposed in the electrolytic solution, which allows for a longer lifetime of the active species even if the oxidation and reduction reactions are repeated.

In the secondary battery including the electrolytic solution, a film may be formed on a surface of a negative electrode (a magnesium-containing material to be described later) upon charging and discharging. Even in such a case, the electrochemically stable active species thus continuously removes the film. That is, the electrochemically stable active species serves to maintain the activity of magnesium even upon repeated charging and discharging. This makes it even easier for the charging and discharging reactions utilizing precipitation and dissolution of magnesium to proceed upon repeated charging and discharging.

Therefore, when the electrolytic solution includes the cyclic unsaturated hydrocarbon compound, in the secondary battery including the electrolytic solution, it becomes easier for the charging and discharging reactions utilizing precipitation and dissolution of magnesium to proceed stably and continuously, and the battery capacity is prevented from decreasing easily even upon repeated charging and discharging.

In particular, the cyclic unsaturated hydrocarbon compound preferably includes the monocyclic ring, that is, preferably includes the monocyclic compound rather than the fused ring compound. One reason for this is that this makes it sufficiently easier for the charging and discharging reactions utilizing precipitation and dissolution of magnesium to proceed, and sufficiently prevents the battery capacity from decreasing easily even upon repeated charging and discharging.

The monocyclic ring is preferably of the fully conjugated system in which two or more carbon-carbon double bonds are alternately positioned via a carbon-carbon single bond, in particular. More specifically, the monocyclic ring preferably includes an annulene including a multiple of 4 carbon atoms. One reason for this is that the cyclic unsaturated hydrocarbon compound exhibits aromaticity in the reduced state. The active species derived from the cyclic unsaturated hydrocarbon compound is thus further stabilized electrochemically, which allows for an even longer lifetime of the cyclic unsaturated hydrocarbon compound. However, as described above, a compound such as benzene that does not include a multiple of 4 carbon atoms is excluded from the annulene described herein.

Here, the “multiple of 4” means what is called a 4n-number (where n is an integer of 1 or greater), and specific examples of the multiple of 4 include 4, 8, and 12. Therefore, a compound such as benzene (the number of carbon atoms is 6) including what is called (4n+2)−number (where n is an integer of 1 or greater) of carbon atoms does not correspond to the annulene including a multiple of 4 carbon atoms. A compound such as benzene including (4n+2)−number of carbon atoms exhibits aromaticity not only in a reduced state but also in a normal molecular state.

The annulene including a multiple of 4 carbon atoms preferably includes cyclooctatetraene, in particular. One reason for this is that the active species derived from the cyclic unsaturated hydrocarbon compound is markedly stabilized electrochemically, which allows for a markedly longer lifetime of the cyclic unsaturated hydrocarbon compound.

Note that the electrolytic solution may further include any one or more of solvents. The solvent is not particularly limited in kind, and specific examples thereof include a non-aqueous solvent (an organic solvent). An electrolytic solution including a non-aqueous solvent is what is called a non-aqueous electrolytic solution.

The non-aqueous solvent is not particularly limited in kind, and preferably includes an ether compound, in particular. One reason for this is that this allows the electrolyte salt to be easily dispersed or dissolved in the non-aqueous solvent by the ether compound, and a state of the electrolytic solution is thus stabilized.

The ether compound is a compound having an ether bond (—O—). Note that the ether compound may be a chain compound or a cyclic compound. The number of ether bonds may be one, or two or more.

Specific examples of the ether compound include dimethoxyethane, diethylene glycol dimethyl ether, tetraethylene glycol dimethyl ether, and tetrahydrofuran.

When manufacturing the electrolytic solution, the electrolyte salt and the additive (the cyclic unsaturated hydrocarbon compound) are added to the solvent. The electrolyte salt and the cyclic unsaturated hydrocarbon compound are thereby dispersed or dissolved in the solvent. As a result, the electrolytic solution is completed.

According to the electrolytic solution, the electrolytic solution includes the electrolyte salt and the additive. The electrolyte salt includes the magnesium salt. The additive includes the cyclic unsaturated hydrocarbon compound.

In this case, as described above, the oxidation and reduction reactions utilizing precipitation and dissolution of magnesium proceeds easily, and the active species derived from the cyclic unsaturated hydrocarbon compound maintains the activity of magnesium in the progress of the precipitation and dissolution reactions of magnesium. Accordingly, in the secondary battery including the electrolytic solution, it becomes easier for the charging and discharging reactions to proceed stably and continuously, and the battery capacity is prevented from decreasing easily even upon repeated charging and discharging. Accordingly, it is possible to achieve a secondary battery having a superior battery characteristic.

In particular, the cyclic unsaturated hydrocarbon compound may include the monocyclic ring, that is, the cyclic unsaturated hydrocarbon compound may include the monocyclic compound. This makes it sufficiently easier for the charging and discharging reactions utilizing precipitation and dissolution of magnesium to proceed, and sufficiently prevents the battery capacity from decreasing easily even upon repeated charging and discharging. Accordingly, it is possible to achieve higher effects.

In this case, the monocyclic ring may include an annulene including a multiple of 4 carbon atoms. This further stabilizes electrochemically the active species derived from the cyclic unsaturated hydrocarbon compound. This therefore allows for an even longer lifetime of the active species. Accordingly, it is possible to achieve even higher effects.

In particular, the annulene may include cyclooctatetraene. This markedly stabilizes electrochemically the active species derived from the cyclic unsaturated hydrocarbon compound. This therefore allows for a markedly longer lifetime of the active species. Accordingly, it is possible to achieve markedly higher effects.

Further, the electrolytic solution may further include an ether compound. This makes it easier for the electrolyte salt to be dispersed or dissolved by the ether compound. This therefore allows for stabilization of the state of the electrolytic solution. Accordingly, it is possible to achieve higher effects.

A description is given next of a secondary battery according to an embodiment of the present technology including the electrolytic solution described above.

In the secondary battery to be described here, the charging and discharging reactions proceed by utilizing precipitation and dissolution of magnesium; accordingly, the secondary battery to be described here is a secondary battery in which the battery capacity is obtained through the charging and discharging reactions.

More specifically, the secondary battery to be described below includes a positive electrode that includes a sulfur-containing material, and a negative electrode that includes a magnesium-containing material, and is therefore what is called a magnesium-sulfur secondary battery. In the secondary battery, magnesium undergoes precipitation and dissolution in the negative electrode, and magnesium undergoes insertion and extraction in an ionic state in the positive electrode. Details of the sulfur-containing material and details of the magnesium-containing material will be described later.

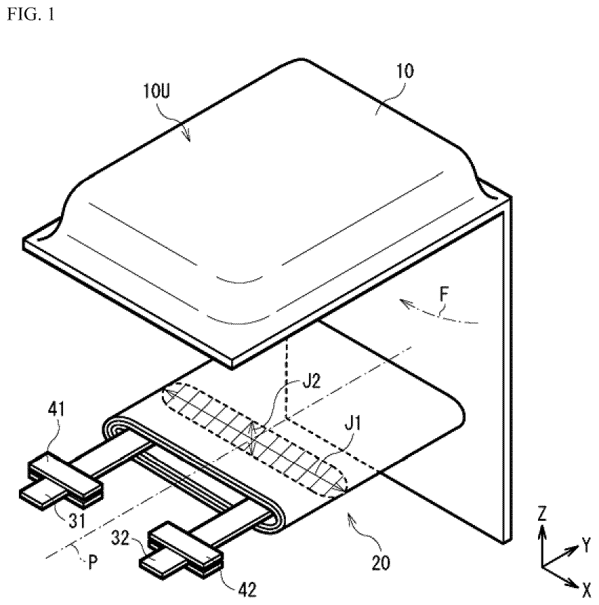

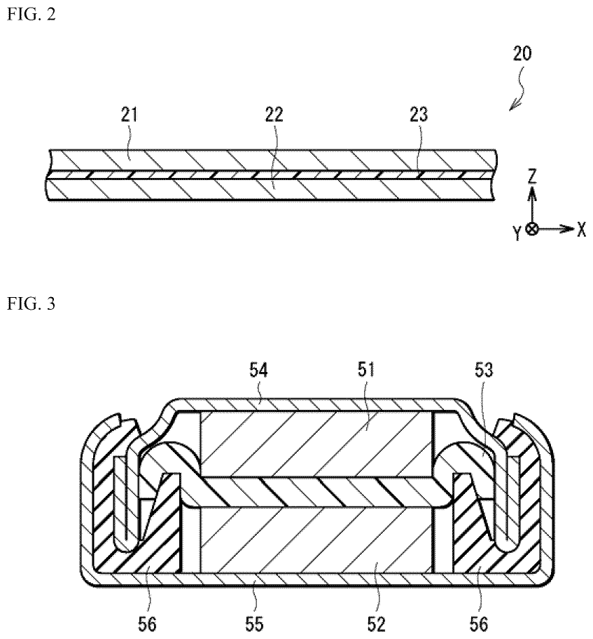

FIG. 1 illustrates a perspective configuration of the secondary battery. FIG. 2 illustrates a sectional configuration of a battery device 20 illustrated in FIG. 1. Note that FIG. 1 illustrates a state where an outer package film 10 and the battery device 20 are separated from each other, and illustrates a section of the battery device 20 along an XZ plane by a dashed line. As illustrated in FIGS. 1 and 2, the secondary battery includes the outer package film 10, the battery device 20, a positive electrode lead 31, a negative electrode lead 32, and sealing films 41 and 42.

The secondary battery described here is a secondary battery of a laminated-film type in which the outer package film 10 having flexibility or softness is used as an outer package member.

As illustrated in FIG. 1, the outer package film 10 has a pouch-shaped structure that is sealed in a state where the battery device 20 is contained inside the outer package film 10. The outer package film 10 thus contains a positive electrode 21, a negative electrode 22, a separator 23, and an electrolytic solution that are to be described later.

Here, the outer package film 10 is a single film-shaped member and is folded in a folding direction F. The outer package film 10 has a depression part 10U to place the battery device 20 therein. The depression part 10U is what is called a deep drawn part.

Specifically, the outer package film 10 is a three-layered laminated film including a fusion-bonding layer, a metal layer, and a surface protective layer stacked in this order from an inner side. In a state where the outer package film 10 is folded, outer edge parts of the fusion-bonding layer opposed to each other are fusion-bonded to each other. The fusion-bonding layer includes a polymer compound such as polypropylene. The metal layer includes a metal material such as aluminum. The surface protective layer includes a polymer compound such as nylon.

Note that the outer package film 10 is not particularly limited in configuration or the number of layers, and may be single-layered or two-layered, or may include four or more layers.

The battery device 20 is a power generation device contained inside the outer package film 10. The battery device 20 includes, as illustrated in FIGS. 1 and 2, the positive electrode 21, the negative electrode 22, the separator 23, and the electrolytic solution (not illustrated).

Here, the battery device 20 is what is called a wound electrode body. That is, the positive electrode 21 and the negative electrode 22 are wound about a winding axis P, being opposed to each other with the separator 23 interposed therebetween. As is apparent from FIG. 1, the winding axis P is a virtual axis extending in a Y-axis direction.

A three-dimensional shape of the battery device 20 is not particularly limited. Here, the battery device 20 has an elongated three-dimensional shape. Accordingly, a section of the battery device 20 intersecting the winding axis P, that is, the section of the battery device 20 along the XZ plane, has an elongated shape defined by a major axis J1 and a minor axis J2.

The major axis J1 is a virtual axis that extends in an X-axis direction and has a length larger than a length of the minor axis J2. The minor axis J2 is a virtual axis that extends in a Z-axis direction intersecting the X-axis direction and has the length smaller than the length of the major axis J1. Here, the battery device 20 has an elongated cylindrical three-dimensional shape. Thus, the section of the battery device 20 has an elongated, substantially elliptical shape.

The positive electrode 21 includes a positive electrode active material into which magnesium is insertable in an ionic state and from which magnesium is extractable in the ionic state. The positive electrode active material includes any one or more of sulfur-containing materials. One reason for this is that this allows magnesium to be easily insertable and extractable in the ionic state into and from the positive electrode 21, which makes it easier for the charging and discharging reactions utilizing precipitation and dissolution of magnesium to proceed.

The sulfur-containing material is a material including sulfur as a constituent element. That is, the sulfur-containing material may be a simple substance of sulfur, an alloy of sulfur, a compound of sulfur, or a mixture of two or more thereof. Note that purity of the simple substance of sulfur is not particularly limited, and the simple substance of sulfur may therefore include any amount of impurity.

One or more metal elements to be included as one or more constituent elements in the alloy of sulfur may be any one or more of desired metal elements, and are not particularly limited in kind. The compound of sulfur includes any one or more of non-metallic elements including, without limitation, carbon, oxygen, and a halogen as one or more constituent elements. Specific examples of the halogen include fluorine, chlorine, bromine, and iodine.

In particular, the positive electrode active material preferably includes the simple substance of sulfur. One reason for this is that this makes it sufficiently easier for the charging and discharging reactions utilizing precipitation and dissolution of magnesium to proceed. FIG. 2 illustrates a case where the positive electrode 21 includes the simple substance of sulfur.

Note that, although not specifically illustrated here, the positive electrode 21 may include a positive electrode current collector and a positive electrode active material layer.

The positive electrode current collector is an electrically conductive support that supports the positive electrode active material layer, and has two opposed surfaces on each of which the positive electrode active material layer is to be provided. The positive electrode current collector includes an electrically conductive material such as a metal material. Specific examples of the electrically conductive material include nickel.

The positive electrode active material layer is supported by the positive electrode current collector, and includes any one or more of sulfur-containing materials as the positive electrode active material. Note that the positive electrode active material layer may further include any one or more of other materials including, without limitation, a positive electrode binder and a positive electrode conductor.

The positive electrode active material layer may be provided on each of the two opposed surfaces of the positive electrode current collector, or may be provided only on one of the two opposed surfaces of the positive electrode current collector. A method of forming the positive electrode active material layer is not particularly limited, and specifically includes any one or more of methods including, without limitation, a coating method.

The positive electrode binder includes any one or more of resin materials including, without limitation, a fluorine-based resin, a polyvinyl-alcohol-based resin, and a styrene-butadiene-copolymer rubber. Specific examples of the fluorine-based resin include polyvinylidene difluoride and polytetrafluoroethylene.

Note that the positive electrode binder may be an electrically conductive polymer compound. Specific examples of the electrically conductive polymer compound include polyaniline, polypyrrole, polythiophene, and a copolymer of two or more thereof. The electrically conductive polymer compound may be unsubstituted, or may be substituted with any one or more functional groups.

The positive electrode conductor includes any one or more of electrically conductive materials including, without limitation, a carbon material, a metal material, and an electrically conductive polymer compound.

Specific examples of the carbon material include graphite (natural graphite and artificial graphite), a carbon fiber, carbon black, and a carbon nanotube. Examples of the carbon fiber include a vapor grown carbon fiber (VGCF). Examples of the carbon black include acetylene black and Ketjen black. Examples of the carbon nanotube include a single-wall carbon nanotube (SWCNT) and a multi-wall carbon nanotube (MWCNT), and examples of the multi-wall carbon nanotube include a double-wall carbon nanotube (DWCNT). Specific examples of the metal material include nickel.

The negative electrode 22 includes any one or more of magnesium-containing materials as the negative electrode active material. One reason for this is that this makes it easier for the charging and discharging reactions utilizing precipitation and dissolution of magnesium to proceed.

The magnesium-containing material is a material including magnesium as a constituent element. That is, the magnesium-containing material may be a simple substance of magnesium, an alloy of magnesium, a compound of magnesium, or a mixture of two or more thereof. Note that purity of magnesium metal is not particularly limited, and the magnesium metal may therefore include any amount of impurity.

One or more metal elements (excluding magnesium) to be included as one or more constituent elements in the alloy of magnesium may be any one or more of desired metal elements, and are not particularly limited in kind. The compound of magnesium includes any one or more of non-metallic elements including, without limitation, carbon, oxygen, sulfur, and a halogen as one or more constituent elements. Specific examples of the halogen include fluorine, chlorine, bromine, and iodine.

In particular, the negative electrode active material preferably includes the simple substance of magnesium. One reason for this is that this makes it sufficiently easier for the charging and discharging reactions utilizing precipitation and dissolution of magnesium to proceed. FIG. 2 illustrates a case where the negative electrode 22 includes the simple substance of magnesium.

The negative electrode 22 may have a configuration similar to that of the positive electrode 21. That is, although not specifically illustrated here, the negative electrode 22 may include a negative electrode current collector and a negative electrode active material layer.

The negative electrode current collector is an electrically conductive support that supports the negative electrode active material layer, and has two opposed surfaces on each of which the negative electrode active material layer is to be provided. The negative electrode current collector includes an electrically conductive material such as a metal material. Specific examples of the electrically conductive material include nickel.

The negative electrode active material layer is supported by the negative electrode current collector, and includes any one or more of magnesium-containing materials as the negative electrode active material. Note that the negative electrode active material layer may further include any one or more of other materials including, without limitation, a negative electrode binder and a negative electrode conductor.

The negative electrode active material layer may be provided on each of the two opposed surfaces of the negative electrode current collector, or may be provided only on one of the two opposed surfaces of the negative electrode current collector. A method of forming the negative electrode active material layer is not particularly limited, and specifically includes any one or more of methods including, without limitation, the coating method.

Details of the negative electrode binder are similar to those of the positive electrode binder. Details of the negative electrode conductor are similar to those of the positive electrode conductor.

The separator 23 is an insulating porous film interposed between the positive electrode 21 and the negative electrode 22 as illustrated in FIG. 2, and allows magnesium to pass therethrough in an ionic state while preventing a short circuit between the positive electrode 21 and the negative electrode 22. The separator 23 includes a polymer compound such as polyethylene.

The electrolytic solution has the configuration described above. That is, the electrolytic solution includes the magnesium salt as the electrolyte salt and the cyclic unsaturated hydrocarbon compound as the additive.

As illustrated in FIGS. 1 and 2, the positive electrode lead 31 is a positive electrode wiring coupled to the positive electrode 21, and is led to an outside of the outer package film 10. Note that when the positive electrode 21 includes the positive electrode current collector, the positive electrode lead 31 is coupled to the positive electrode current collector. The positive electrode lead 31 includes an electrically conductive material such as a metal material. Specific examples of the electrically conductive material include aluminum. The positive electrode lead 31 has any one of shapes including, without limitation, a thin plate shape and a meshed shape.

As illustrated in FIGS. 1 and 2, the negative electrode lead 32 is a negative electrode wiring coupled to the negative electrode 22, and is led to the outside of the outer package film 10. Note that when the negative electrode 22 includes the negative electrode current collector, the negative electrode lead 32 is coupled to the negative electrode current collector. Here, the negative electrode lead 32 is led in a direction similar to a direction in which the positive electrode lead 31 is led. The negative electrode lead 32 includes an electrically conductive material such as a metal material. Specific examples of the electrically conductive material include copper. Note that details of a shape of the negative electrode lead 32 are similar to those of the shape of the positive electrode lead 31.

The sealing film 41 is interposed between the outer package film 10 and the positive electrode lead 31. The sealing film 42 is interposed between the outer package film 10 and the negative electrode lead 32. Note that the sealing film 41, the sealing film 42, or both may be omitted.

The sealing film 41 is a sealing member that prevents entry of, for example, outside air into the outer package film 10. The sealing film 41 includes a polymer compound such as a polyolefin that has adherence to the positive electrode lead 31. Specific examples of the polymer compound include polypropylene.

The sealing film 42 has a configuration similar to that of the sealing film 41 except that the sealing film 42 is a sealing member that has adherence to the negative electrode lead 32. That is, the sealing film 42 includes a polymer compound such as a polyolefin that has adherence to the negative electrode lead 32.

The secondary battery operates as described below in the battery device 20.

Upon discharging the secondary battery, the magnesium-containing material is dissolved in the negative electrode 22, which causes magnesium to be eluted into the electrolytic solution, and the eluted magnesium is inserted into the positive electrode 21 in an ionic state. Upon charging the secondary battery, magnesium is extracted from the positive electrode 21 into the electrolytic solution in an ionic state, and the extracted magnesium is precipitated on the negative electrode 22.

When manufacturing the secondary battery, the positive electrode 21 and the negative electrode 22 are prepared, following which the secondary battery is assembled using the positive electrode 21, the negative electrode 22, and the electrolytic solution, in accordance with an exemplary procedure to be described below.

A description is given below of a case where the simple substance of sulfur (sulfur powder) is used as the sulfur-containing material and the simple substance of magnesium (magnesium metal) is used as the magnesium-containing material. Note that a procedure of manufacturing the electrolytic solution has already been described above, and is thus not described below.

First, the positive electrode active material (sulfur powder as the sulfur-containing material), the positive electrode binder, and the positive electrode conductor are mixed with each other to thereby obtain a positive electrode mixture. Thereafter, the positive electrode mixture is put into a solvent to thereby prepare a positive electrode mixture slurry in paste form. The solvent may be an aqueous solvent, or may be an organic solvent. Lastly, the positive electrode mixture slurry is applied on the two opposed surfaces of the positive electrode current collector to thereby form the positive electrode active material layers. Thereafter, the positive electrode active material layers may be compression-molded using, for example, a roll pressing machine. In this case, the positive electrode active material layers may be heated. The positive electrode active material layers may be compression-molded multiple times. The positive electrode active material layers are thus formed on the two respective opposed surfaces of the positive electrode current collector. As a result, the positive electrode 21 is fabricated.

As the negative electrode 22, the negative electrode active material (magnesium metal as the magnesium-containing material) is prepared. Used as the magnesium metal is a magnesium foil.

First, the positive electrode lead 31 is coupled to the positive electrode 21 by a joining method such as a welding method, and the negative electrode lead 32 is coupled to the negative electrode 22 by the joining method such as the welding method.

Thereafter, the positive electrode 21 and the negative electrode 22 are stacked on each other with the separator 23 interposed therebetween, following which the stack of the positive electrode 21, the negative electrode 22, and the separator 23 is wound to thereby form a wound body (not illustrated). Thereafter, the wound body is pressed using, for example, a pressing machine to thereby shape the wound body into an elongated shape. The shaped wound body has a configuration similar to that of the battery device 20 except that the positive electrode 21, the negative electrode 22, and the separator 23 are each not impregnated with the electrolytic solution.

Thereafter, the wound body is placed inside the depression part 10U, following which the outer package film 10 (the fusion-bonding layer/the metal layer/the surface protective layer) is folded to thereby cause portions of the outer package film 10 to be opposed to each other. Thereafter, outer edge parts of two sides of the fusion-bonding layer opposed to each other are bonded to each other by a bonding method such as a thermal-fusion-bonding method to thereby allow the wound body to be contained inside the outer package film 10 having a pouch shape.

Lastly, the electrolytic solution is injected into the outer package film 10 having the pouch shape, following which outer edge parts of the remaining one side of the fusion-bonding layer opposed to each other are bonded to each other by the bonding method such as the thermal-fusion-bonding method. In this case, the sealing film 41 is interposed between the outer package film 10 and the positive electrode lead 31, and the sealing film 42 is interposed between the outer package film 10 and the negative electrode lead 32.

The wound body is thereby impregnated with the electrolytic solution, and the battery device 20 that is the wound electrode body is thus formed. Accordingly, the battery device 20 is sealed in the outer package film 10 having the pouch shape. The secondary battery is thus completed.

According to the secondary battery, the secondary battery includes the electrolytic solution, and the electrolytic solution has the above-described configuration. In this case, for the reason described above, it becomes easier for the charging and discharging reactions to proceed stably and continuously, and the battery capacity is prevented from decreasing easily even upon repeated charging and discharging. Accordingly, it is possible to achieve a superior battery characteristic.

In particular, the positive electrode 21 may include the sulfur-containing material, and the negative electrode 22 may include the magnesium-containing material. This makes it sufficiently easier for the charging and discharging reactions utilizing precipitation and dissolution of magnesium to proceed, and sufficiently prevents the battery capacity from decreasing easily even upon repeated charging and discharging. Accordingly, it is possible to achieve higher effects. In this case, the sulfur-containing material may include the simple substance of sulfur, and the magnesium-containing material may include the simple substance of magnesium. This makes it even easier for the charging and discharging reactions to proceed, and further prevents the battery capacity from decreasing easily. Accordingly, it is possible to achieve even higher effects.

Further, the secondary battery may include a magnesium-sulfur secondary battery. This makes it possible to obtain a sufficient battery capacity through precipitation and dissolution of magnesium. Accordingly, it is possible to achieve higher effects.

Applications (application examples) of the secondary battery are not particularly limited. The secondary battery used as a power source may serve as a main power source or an auxiliary power source of, for example, electronic equipment or an electric vehicle. The main power source is preferentially used regardless of the presence of any other power source. The auxiliary power source may be used in place of the main power source, or may be switched from the main power source.

Specific examples of the applications of the secondary battery include electronic equipment, apparatuses for data storage, electric power tools, battery packs, medical electronic equipment, electric vehicles, and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. The battery pack is to be mounted on, for example, electronic equipment. Examples of the medical electronic equipment include pacemakers and hearing aids. Examples of the electric vehicles include electric automobiles including hybrid automobiles. Examples of the electric power storage systems include battery systems for home use or industrial use in which electric power is accumulated for a situation such as emergency. In each of the above-described applications, only one secondary battery may be used, or two or more secondary batteries may be used.

The battery packs may each include a battery cell, or may each include an assembled battery. The electric vehicle is a vehicle that travels with the secondary battery as a driving power source, and may be a hybrid automobile that is additionally provided with a driving source other than the secondary battery. In the electric power storage system for home use, electric power accumulated in the secondary battery serving as an electric power storage source may be utilized for using, for example, home appliances.

### EXAMPLES

A description is given of Examples of the present technology according to an embodiment.

Electrolytic solutions and secondary batteries were manufactured, following which the electrolytic solutions were each evaluated for a physical property and the secondary batteries were each evaluated for a battery characteristic as described below.

### Examples 1 and 2 and Comparative Examples 1 to 4

First, electrolytic solutions were manufactured, following which the electrolytic solutions were each evaluated for a physical property, in accordance with the following procedure.

### [Manufacturing of Electrolytic Solution]

The electrolyte salt (the magnesium salt) and the additive (cyclooctatetraene (COT), available from Tokyo Chemical Industry Co., Ltd., as the cyclic unsaturated hydrocarbon compound) were added to the solvent (diethylene glycol dimethyl ether (DGDE), available from Tomiyama Pure Chemical Industries, Ltd., as the ether compound), following which the solvent was stirred. The electrolytic solution was thus prepared.

Used as the electrolyte salt was a mixture of magnesium bis(trifluoromethanesulfonyl)imide (MgTFSI₂, available from Tomiyama Pure Chemical Industries, Ltd.) and magnesium chloride (MgCl₂, available from Sigma-Aldrich Co. LLC). In this case, a content of magnesium bis(trifluoromethanesulfonyl)imide in the electrolytic solution was set to 0.2 mol/l (=0.2 mol/dm³) with respect to the solvent, and a content of the magnesium chloride in the electrolytic solution was set to 0.2 mol/l with respect to the solvent.

In some cases, magnesium chloride was used alone as the electrolyte salt. In such cases, a content of magnesium chloride in the electrolytic solution was set to 0.4 mol/l with respect to the solvent.

A content of cyclooctatetraene in the electrolytic solution was set to 0.05 mol/l with respect to the solvent.

Note that an electrolytic solution for comparison was prepared by a similar procedure, except that no additive was used. In addition, an electrolytic solution for comparison was prepared by a similar procedure, except that the cyclic unsaturated hydrocarbon compound as the additive was replaced with another compound (anthracene (ANT), available from Tokyo Chemical Industry Co., Ltd.).

After the preparation of the electrolytic solution, the electrolytic solution was analyzed by ICP optical emission spectroscopy. As a result, it was confirmed that the content of the electrolyte salt and the content of the additive (the cyclic unsaturated hydrocarbon compound or the other compound) were as described above.

### [Evaluation of Physical Property]

The electrolytic solutions were each evaluated for an oxidation-reduction characteristic as the physical property. The evaluation revealed the results presented in Table 1.

When evaluating the oxidation-reduction characteristic, first, a working electrode (platinum), a reference electrode (magnesium), and a counter electrode (magnesium) were immersed in the electrolytic solution. Thereafter, a correlative relationship between a potential and a current was measured (i.e., a cyclic voltammogram was created) in an ambient temperature environment (at a temperature of 25° C.) by cyclic voltammetry. In this case, a sweep rate was set to 25 m V/sec, a potential range was set to a range from −2 V to 2 V both inclusive, and the number of cycles was set to 10 cycles. Lastly, based on the cyclic voltammogram, whether the oxidation and reduction reactions proceeded, which was an index for evaluating the oxidation-reduction characteristic, was determined.

The column of “oxidation and reduction reactions” in Table 1 indicates tendencies described below.

“Yes” indicates that the activity was exhibited not only at the time of precipitation of magnesium but also at the time of dissolution of magnesium, and that the oxidation and reduction reactions thus proceeded. That is, it indicates that the charging and discharging reactions proceeded in the secondary battery including the electrolytic solution.

“No” indicates that the activity was not exhibited at the time of dissolution of magnesium, and that the oxidation and reduction reactions thus did not proceed sufficiently. That is, it indicates that the charging and discharging reactions did not proceed in the secondary battery including the electrolytic solution.

TABLE 1

| | | | | Oxidation |
|---|---|---|---|---|
| | Electrolytic solution | | | and reduction |
| | Solvent | Electrolyte salt | Additive | reactions |
| Example 1 | DGDE | MgTFSI₂ + MgCl₂ | COT | Yes |
| Example 2 | DGDE | MgTFSI₂ | COT | Yes |
| Comparative | DGDE | MgTFSI₂ + MgCl₂ | — | Yes |
| example 1 | | | | |
| Comparative | DGDE | MgTFSI₂ | — | No |
| example 2 | | | | |
| Comparative | DGDE | MgTFSI₂ + MgCl₂ | ANT | Yes |
| example 3 | | | | |
| Comparative | DGDE | MgTFSI₂ | ANT | No |
| example 4 | | | | |

As indicated in Table 1, whether the oxidation and reduction reactions proceeded varied depending on the configuration of the electrolytic solution.

Specifically, in a case where the additive was not used (Comparative examples 1 and 2), a difference occurred in whether the oxidation and reduction reactions proceeded. That is, in a case where the mixture of magnesium bis(trifluoromethanesulfonyl)imide and magnesium chloride was used as the electrolyte salt (Comparative example 1), the oxidation and reduction reactions proceeded. However, in a case where only magnesium bis(trifluoromethanesulfonyl)imide was used as the electrolyte salt (Comparative example 2), the oxidation and reduction reactions did not proceed.

Similarly, in a case where the other compound (anthracene) was used as the additive (Comparative examples 3 and 4) also, a difference occurred in whether the oxidation and reduction reactions proceeded. That is, in a case where the mixture of magnesium bis(trifluoromethanesulfonyl)imide and magnesium chloride was used as the electrolyte salt (Comparative example 3), the oxidation and reduction reactions proceeded. However, in a case where only magnesium bis(trifluoromethanesulfonyl)imide was used as the electrolyte salt (Comparative example 4), the oxidation and reduction reactions did not proceed.

Therefore, in each of the case where the additive was not used (Comparative examples 1 and 2) and the case where the other compound (anthracene) was used as the additive (Comparative examples 3 and 4), whether the oxidation and reduction reactions proceeded differed depending on the kind of electrolyte salt.

In contrast, in a case where the cyclic unsaturated hydrocarbon compound (cyclooctatetraene) was used as the additive (Examples 1 and 2), no difference occurred in whether the oxidation and reduction reactions proceeded. That is, in a case where the mixture of magnesium bis(trifluoromethanesulfonyl)imide and magnesium chloride was used as the electrolyte salt (Example 1), the oxidation and reduction reactions proceeded. Similarly, in a case where only magnesium bis(trifluoromethanesulfonyl)imide was used as the electrolyte salt (Example 2) also, the oxidation and reduction reactions proceeded.

Therefore, in the case where the cyclic unsaturated hydrocarbon compound was used as the additive (Examples 1 and 2), the oxidation and reduction reactions proceeded stably without depending on the kind of the electrolyte salt.

### Example 3 and Comparative Examples 5 and 6

Next, secondary batteries were manufactured, following which the secondary batteries were each evaluated for a battery characteristic, in accordance with the following procedure.

### [Manufacturing of Secondary Battery]

Here, a test secondary battery was fabricated to conduct a simple evaluation as the evaluation for the battery characteristic. FIG. 3 illustrates a sectional configuration of the test secondary battery (a magnesium-sulfur secondary battery of a coin type).

In the following, a configuration of the test secondary battery is described, following which a procedure of manufacturing the test secondary battery is described.

### [Configuration of Test Secondary Battery]

As illustrated in FIG. 3, the test secondary battery included a test electrode 51, a counter electrode 52, a separator 53, an outer package cup 54, an outer package can 55, a gasket 56, and an electrolytic solution (not illustrated).

The test electrode 51 was placed inside the outer package cup 54, and the counter electrode 52 was placed inside the outer package can 55. The test electrode 51 and the counter electrode 52 were stacked on each other with the separator 53 interposed therebetween. The test electrode 51, the counter electrode 52, and the separator 53 were each impregnated with the electrolytic solution. The outer package cup 54 and the outer package can 55 were crimped to each other with the gasket 56 interposed therebetween. The test electrode 51, the counter electrode 52, and the separator 53 were thus sealed in the outer package cup 54 and the outer package can 55.

### [Procedure of Manufacturing Test Secondary Battery]

The procedure of manufacturing the test secondary battery is as described below.

### [Fabrication of Test Electrode]

First, 10 parts by mass of a positive electrode active material (sulfur powder as the sulfur-containing material), 30 parts by mass of a positive electrode binder (polytetrafluoroethylene available from AGC Inc.), and 60 parts by mass of a positive electrode conductor (Ketjen black, ECP600JD available from Lion Corporation) were mixed with each other to thereby obtain a mixture. Thereafter, the mixture was compression-molded using a roll pressing machine to thereby form a mixture sheet having a thickness of 100 μm. Lastly, the mixture sheet was punched into a disk shape having a diameter of 15 mm. In this manner, the test electrode 51 was fabricated.

### [Preparation of Counter Electrode]

As the counter electrode 52 (magnesium metal as the magnesium-containing material), a disk-shaped magnesium plate (having a thickness of 200 μm, a diameter of 16 mm, and a purity of 99.9%, available from RIKAZAI CO., LTD.) was prepared.

### [Preparation of Electrolytic Solution]

The electrolytic solutions of Example 1 and Comparative examples 1 and 3 described above were prepared.

### [Assembly of Test Secondary Battery]

First, the test electrode 51 was placed in the outer package cup 54, and the counter electrode 52 was placed in the outer package can 55. Thereafter, the test electrode 51 placed in the outer package cup 54 and the counter electrode 52 placed in the outer package can 55 were stacked on each other with the separator 53 (a glass fiber having a thickness of 200 μm, GC50 available from Advantech Corporation) impregnated with the electrolytic solution being interposed between the test electrode 51 and the counter electrode 52. In this case, the test electrode 51 was so disposed that the positive electrode active material layer was opposed to the counter electrode 52 with the separator 53 interposed therebetween. Lastly, the outer package cup 54 and the outer package can 55 were crimped to each other with the gasket 56 interposed therebetween in a state where the test electrode 51 and the counter electrode 52 were stacked on each other with the separator 53 interposed therebetween. The test electrode 51 and the counter electrode 52 were thereby sealed in the outer package cup 54 and the outer package can 55. The test secondary battery was thus completed.

### [Evaluation of Battery Characteristic]

The test secondary batteries were each evaluated for a cyclability characteristic as the battery characteristic. The evaluation revealed the results presented in Table 2.

To evaluate the cyclability characteristic, first, the test secondary battery was charged and discharged for two cycles in an ambient temperature environment (at a temperature of 25° C.) to stabilize a state of the test secondary battery.

Thereafter, the test secondary battery was charged and discharged for one cycle in the same environment to thereby measure a discharge capacity (a third-cycle discharge capacity). Thereafter, the test secondary battery was charged and discharged for seven cycles in the same environment to thereby measure the discharge capacity (a 10th-cycle discharge capacity).

Lastly, a capacity retention rate that was an index for evaluating the cyclability characteristic was calculated based on the following calculation expression: capacity retention rate (%)=(10th-cycle discharge capacity/third-cycle discharge capacity)×100.

Note that, upon discharging, the test secondary battery was discharged with a constant current of 0.1 mA until a voltage reached 0.8 V, and upon charging, the test secondary battery was charged with a constant current of 0.1 mA until the voltage reached 2.4 V.

TABLE 2

| | Test | Counter | | | | |
|---|---|---|---|---|---|---|
| | electrode | electrode | | | | Capacity |
| | Sulfur- | Magnesium- | | | | retention |
| | containing | containing | Electrolytic solution | | | rate |
| | material | material | Solvent | Electrolyte salt | Additive | (%) |
| Example 3 | Sulfur | Magnesium | DGDE | MgTFSI₂ + MgCl₂ | COT | 82 |
| | powder | metal | | | | |
| Comparative | Sulfur | Magnesium | DGDE | MgTFSI₂ + MgCl₂ | — | 70 |
| example 5 | powder | metal | | | | |
| Comparative | Sulfur | Magnesium | DGDE | MgTFSI₂ + MgCl₂ | ANT | 71 |
| example 6 | powder | metal | | | | |

As indicated in Table 2, the capacity retention rate varied greatly depending on the configuration of the electrolytic solution.

Specifically, in a case where the electrolytic solution included the cyclic unsaturated hydrocarbon compound (cyclooctatetraene) as the additive (Example 3), the capacity retention rate increased, as compared with a case where the electrolytic solution included no additive (Comparative example 5) and a case where the electrolytic solution included the other compound (anthracene) as the additive (Comparative example 6).

In particular, in the case where the electrolytic solution included the cyclic unsaturated hydrocarbon compound as the additive, a sufficient capacity retention rate was obtained if the solvent included the ether compound (diethylene glycol dimethyl ether).

Based upon the results presented in Tables 1 to 2, when the electrolytic solution included the magnesium salt and the cyclic unsaturated hydrocarbon compound, a high capacity retention rate was obtained. Accordingly, the cyclability characteristic improved. It was therefore possible to achieve a superior battery characteristic.

Although the present technology has been described above with reference to one or more embodiments including Examples, the configuration of the present technology is not limited thereto, and is therefore modifiable in a variety of ways.

Specifically, the description has been given of the case where the secondary battery has a battery structure of the laminated-film type or the coin type. However, the battery structure of the secondary battery is not particularly limited, and may be, for example, of a cylindrical type, a prismatic type, or a button type.

Further, the description has been given of the case where the battery device has a device structure of a wound type. However, the device structure of the battery device is not particularly limited, and may be, for example, of a stacked type or a zigzag folded type. In the stacked type, the positive electrode and the negative electrode are stacked on each other. In the zigzag folded type, the positive electrode and the negative electrode are folded in a zigzag manner.

The effects described herein are mere examples, and effects of the present technology are therefore not limited to those described herein. Accordingly, the present technology may achieve any other effect.

Note that the present technology may have the following configurations according to an embodiment.

<1>

A secondary battery including:
a positive electrode;
a negative electrode; and
an electrolytic solution including a magnesium salt and a cyclic unsaturated hydrocarbon compound, in which
the cyclic unsaturated hydrocarbon compound includes a monocyclic ring including multiple carbon atoms or a bicyclic fused ring including multiple carbon atoms,
the monocyclic ring or the bicyclic fused ring includes two or more carbon-carbon double bonds,
the bicyclic fused ring includes no benzene ring,
a number of the carbon-carbon double bonds when a number of the carbon atoms included in the monocyclic ring is 7 or less is an even number,
a number of the carbon-carbon double bonds when the number of the carbon atoms included in the monocyclic ring is 8 or more is an odd number or an even number, and
a number of the carbon-carbon double bonds in the bicyclic fused ring is an odd number or an even number.
   <2>

The secondary battery according to <1>, in which the cyclic unsaturated hydrocarbon compound includes the monocyclic ring.

<3>

The secondary battery according to <2>, in which the monocyclic ring includes an annulene including a multiple of 4 carbon atoms.

<4>

The secondary battery according to <3>, in which the annulene includes cyclooctatetraene.

<5>

The secondary battery according to any one of <1> to <4>, in which
the positive electrode includes a sulfur-containing material, and
the negative electrode includes a magnesium-containing material.
   <6>

The secondary battery according to <5>, in which
the sulfur-containing material includes a simple substance of sulfur, and
the magnesium-containing material includes a simple substance of magnesium.
   <7>

The secondary battery according to any one of <1> to <6>, in which the electrolytic solution further includes an ether compound.

<8>

The secondary battery according to any one of <1> to <7>, in which the secondary battery includes a magnesium-sulfur secondary battery.

<9>

An electrolytic solution for a secondary battery, the electrolytic solution including:
a magnesium salt; and
a cyclic unsaturated hydrocarbon compound, in which
the cyclic unsaturated hydrocarbon compound includes a monocyclic ring including multiple carbon atoms or a bicyclic fused ring including multiple carbon atoms,
the monocyclic ring or the bicyclic fused ring includes two or more carbon-carbon double bonds,
the bicyclic fused ring includes no benzene ring,
a number of the carbon-carbon double bonds when a number of the carbon atoms included in the monocyclic ring is 7 or less is an even number,
a number of the carbon-carbon double bonds when the number of the carbon atoms included in the monocyclic ring is 8 or more is an odd number or an even number, and
a number of the carbon-carbon double bonds in the bicyclic fused ring is an odd number or an even number.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims

1. A secondary battery comprising:
a positive electrode;
a negative electrode; and
an electrolytic solution including a magnesium salt and a cyclic unsaturated hydrocarbon compound, wherein
the cyclic unsaturated hydrocarbon compound includes a monocyclic ring including multiple carbon atoms or a bicyclic fused ring including multiple carbon atoms,
the monocyclic ring or the bicyclic fused ring includes two or more carbon-carbon double bonds,
the bicyclic fused ring includes no benzene ring,
a number of the carbon-carbon double bonds when a number of the carbon atoms included in the monocyclic ring is 7 or less is an even number,
a number of the carbon-carbon double bonds when the number of the carbon atoms included in the monocyclic ring is 8 or more is an odd number or an even number, and
a number of the carbon-carbon double bonds in the bicyclic fused ring is an odd number or an even number.

2. The secondary battery according to claim 1, wherein the cyclic unsaturated hydrocarbon compound includes the monocyclic ring.

3. The secondary battery according to claim 2, wherein the monocyclic ring includes an annulene including a multiple of 4 carbon atoms.

4. The secondary battery according to claim 3, wherein the annulene includes cyclooctatetraene.

5. The secondary battery according to claim 1, wherein
the positive electrode includes a sulfur-containing material, and
the negative electrode includes a magnesium-containing material.

6. The secondary battery according to claim 5, wherein
the sulfur-containing material includes a simple substance of sulfur, and
the magnesium-containing material includes a simple substance of magnesium.

7. The secondary battery according to claim 1, wherein the electrolytic solution further includes an ether compound.

8. The secondary battery according to claim 1, wherein the secondary battery comprises a magnesium-sulfur secondary battery.

9. An electrolytic solution for a secondary battery, the electrolytic solution comprising:
a magnesium salt; and
a cyclic unsaturated hydrocarbon compound, wherein
the cyclic unsaturated hydrocarbon compound includes a monocyclic ring including multiple carbon atoms or a bicyclic fused ring including multiple carbon atoms,
the monocyclic ring or the bicyclic fused ring includes two or more carbon-carbon double bonds,
the bicyclic fused ring includes no benzene ring,
a number of the carbon-carbon double bonds when a number of the carbon atoms included in the monocyclic ring is 7 or less is an even number,
a number of the carbon-carbon double bonds when the number of the carbon atoms included in the monocyclic ring is 8 or more is an odd number or an even number, and
a number of the carbon-carbon double bonds in the bicyclic fused ring is an odd number or an even number.
